(19) United States
(12) Patent Application Publication
(10) Pub. No.: US 2020/0134052 A1
(43) Pub. Date: Apr. 30, 2020

(54) DECENTRALIZED DISTRIBUTION USING AN OVERLAY NETWORK

(71) Applicant: EMC IP Holding Company LLC, Hopkinton, MA (US)

(72) Inventors: Assaf Natanzon, Tel Aviv (IL); Pengfei Wu, Shanghai (CN); Kun Wang, Beijing (CN)

(21) Appl. No.: 16/171,639

(22) Filed: Oct. 26, 2018

(51) Int. Cl. G06F 17/30

(52) U.S. Cl. CPC G06F 17/30174; G06F 17/30215

(57) ABSTRACT

Data replication in a distributed file network. When replicating an object from a source node to target nodes, an overlay plan is developed. The plan may consider bandwidth between the nodes such that the object is replicated more effectively. As a result, chunks of the object may pass through multiple nodes. As a result, more than one node or site can serve as a source for some of the chunks. When the replication process is completed, the source node or site and the target node or site each have a copy or replica of the object.

### FIELD OF THE INVENTION

Embodiments of the present invention relate to systems and methods for storing data. More particularly, embodiments of the invention relate to systems and methods for managing data including the locations and number of data replicas. More particularly, embodiments relate to systems and methods for replicating objects in a distributed file system.

### BACKGROUND

InterPlanetary File System (IPFS) is an example of a file system for storing and sharing data or objects in a distributed file system. In contrast to HTTP (Hyper Text Transfer Protocol), which typically downloads a file from a single computer, IPFS may allow pieces of a file to be retrieved from multiple computers at the same time. In fact, IPFS allows multiple copies of an object to be stored in the distributed file system and accessed when needed. IPFS, however, does not address issues related to efficiently creating all of the copies or replicas in the distributed file system. Traditionally, when separate copies of an object are needed, the object is copied from the source to all of the targets.

### BRIEF DESCRIPTION OF THE DRAWINGS

In order to describe the manner in which at least some aspects of this disclosure can be obtained, a more particular description will be rendered by reference to specific embodiments thereof which are illustrated in the appended drawings. Understanding that these drawings depict only example embodiments of the invention and are not therefore to be considered to be limiting of its scope, embodiments of the invention will be described and explained with additional specificity and detail through the use of the accompanying drawings, in which:

FIG. 1 illustrates an example of transferring an object in a distributed file system;

FIG. 2 illustrates an example of systems, apparatus and methods for replicating an object in a distributed file system;

FIG. 3 illustrates another example of systems, apparatus and methods replicating an object using an overlay in a distributed network; and

FIG. 4 illustrates an example of a method for replicating an object in a distributed file system.

### DETAILED DESCRIPTION OF SOME EXAMPLE EMBODIMENTS

Embodiments of the invention relate to systems and methods for replicating data. Data may be replicated during various operations that may include, but are not limited to, storage operations, write operations, data protection operations such as backup operations, data lake operations, or the like or combination thereof.

Embodiments of the invention relate, more particularly, to systems, apparatus, and methods for transferring data in computing system and more particularly to transferring data in a distributed file system. Examples of a computing system or a distributed file system include cloud based computing systems and the like. In one example, a distributed file system is a system of computing devices (e.g., servers, storage, clients, etc.) that allows files to be accessed from multiple hosts and that stores data, including replicas of data, in different stores or sites.

Embodiments of the invention are discussed in the context of distributing or replicating an object. However, an object is an example of data and embodiments of the invention may be similarly applied to files, blocks, chunks of data or the like or combination thereof.

In one example, a file level overlay is disclosed. The file level overlay may be used when distributing an object in a distributed file system. When distributing or transferring an object such that the object is replicated to multiple locations or sites, the object is transferred or replicated in a manner that improves or optimizes the usage of network resources including bandwidth. Although the object may be transferred from the source to each of the destination targets, embodiments of the invention may contemplate or consider the network resources prior to distributing the object. This allows the replication of the object to be performed in a smart and more efficient manner compared to simply copying the object from the source to each of the identified locations in the distributed file system.

In one example, the object may by chunked into chunks and the chunks are transferred or replicated to the destinations. When replicating the chunks, embodiments of the invention contemplate the network capabilities including bandwidth and then transfer the chunks in an optimal manner. In addition, if the distributed file system is deduplicated, the unique chunks may be identified and it may only be necessary to transfer the unique chunks. In addition, the chunks may be encrypted.

Embodiments of the invention may distribute the chunks in a manner that allows the chunks to be distributed by more than the source of the object. For example, a source may transfer some of the chunks to a first target and transfer the rest of the chunks to a second target. The first and second targets can then exchange chunks. This allows the transfer or replication to be achieved in a more optimal manner. In some instances, the process of transferring chunks may use a node or server that is not an ultimate target. This node acts as an overlay or a proxy. In another example, some of the chunks may already exist on another site. In this case, it may be possible to replicate an object using existing chunks from another location or site.

Embodiments of the invention may also prioritize the manner in which chunks are replicated. For example, chunks that are rarer in the distributed file system may be replicated before chunks that have more replicas.

In one example, the desired number of copies or replicas of an object may be known in advance. The importance or priority of each copy may also be known. A data protection policy associated with the object, for example, may set forth the priority of each replica. This information allows the source site and the target site to create a transfer layer or plan. The transfer layer results in a plan that determines which chunks to send to which target such that the network can be better utilized. Embodiments may also use nodes, that are not intended targets, to store copies of the object as overlays or temporarily when the network utilization is improved by using the nodes to replicate the object. Once the plan or overlay is determined, the chunks are distributed in accordance with the plan such that all copies or replicas are stored at the intended sites or locations.

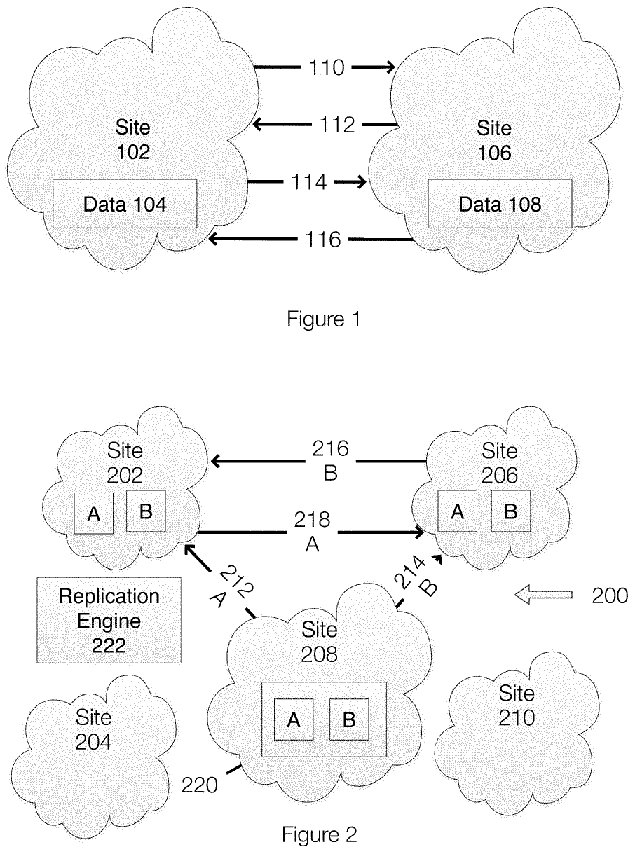

FIG. 1 illustrates an example of a distributed file system in which objects are replicated. FIG. 1 illustrates a site 102 and a site 106. The sites 102, 106 are examples of data stores (e.g., cloud based storage, datacenters, or other storage). The site 102 stores data 104 and the site 106 stores data 108. Some of the objects in the data 104 may be the same as some of the objects in the data 108. Thus, these objects are replicated on the sites 102 and 106.

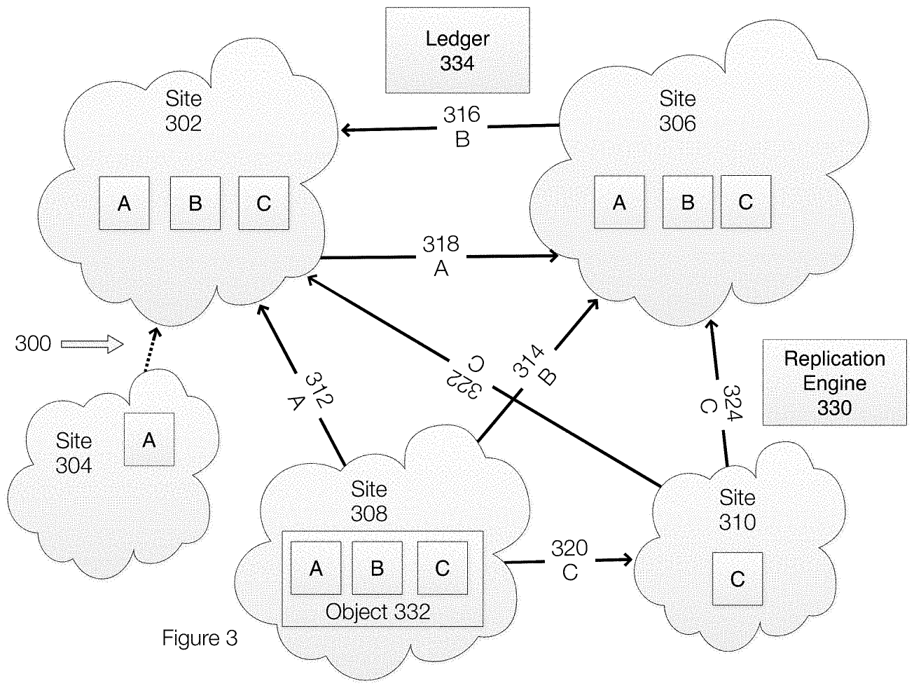

The site 102 is associated with an uplink 110 and a downlink 112. Similarly, the site 106 is associated with an uplink 116 and a downlink 114. Each of these links is typically associated with a bandwidth. Further, the bandwidth may be limited by one of the sites 102 and 106. For example, the site 106 may be able to receive data at a rate that is higher than the rate at which the site 102 can transmit the data. Thus, the connection may be limited by the lower rate. When developing a plan for replicating an object, the bandwidth of the sites in the distributed network may be considered such that the object can be replicated more efficiently. This is further illustrated in FIGS. 2 and 3.

FIG. 2 illustrates an example of a distributed file system in which an object is replicated. FIG. 2 illustrates an distributed file system 200 that includes multiple sites or storage locations: sites 202, 204, 206, 208, and 210. The sites 202, 204, 206, 208 and 210 are typically connected by a network connection (e.g., the Internet) and may be connected with client devices that access the distributed file system 200.

FIG. 2 illustrates that an object 220 is stored at the site 208 and it is determined that the object 220 is to be replicated to the site 202 and to the site 206. Initially, the deduplicated file system may include a replication engine 222 operating on one or more of the sites 202, 204, 206, 208, 210. The replication engine 222 may be tasked with replicating the object 220 to the sites 202 and 206.

In one example, the replication engine 222 may first chunk the object 220. In this example, the object 220 is chunked into chunk A and chunk B. The object 220 may have been chunked when initially stored in the site 208. Next, the replication engine 222 may develop a plan for replicating the object 220 by considering the connections between the sites directly involved in the replication. In this example, the sites directly involved in the replication include the site 208 (because the object 220 is stored at the site 208) and the sites 202 and 206 (because the sites 202 and 206 are targets or destinations of the replicas.

The replication engine 222 may evaluate the bandwidth between the site 202 and the site 208, the bandwidth between the site 208 and the site 206, and the bandwidth between the site 202 and the site 206. Other factors may also be considered when developing the plan. For example, traffic levels at the various sites, transit times, geographic locations, and the like may also be considered.

In this example, the replication engine determines that the object 220 is replicated by sending 212 the chunk A to the site 202 and by sending 214 the chunk B to the site 206. The site 202 then sends 216 the chunk A to the site 206 and the site 206 sends 216 the chunk B to the site 202. Once these transfers have been completed, the object 220 has been replicated from the site 208 to the sites 202 and 206. Thus, each of the sites 202, 206 and 208 have a copy or replica of the object 220.

The plan developed by the replication engine 222 allowed the object 220 to be replicated in a manner in a manner that better utilizes the network. In this example, the object 220 (or chunks of the object) were copies from multiple sources. For example, the chunk A was copied to site 202 from the site 208. Then, the site 202 acted as a source and copies the chunk A to the site 206. This allows more efficiency, particularly when the downlink is much larger than the uplink. Embodiments of the invention also improve the speed at which an object is replicated to multiple locations. The replication engine 222 is able to coordinate the replication process and optimize the various links in the plan for each of the chunks. Further, using multiple sites or nodes can create higher efficiency in part because the capacity of any particular node is limited. Thus, the plan shown in FIG. 2 allows the capacity of three sites to be used to replicate the data as each of the sites 202, 206 and 208 each act as a source during at least a part of the replication process.

As illustrated in FIG. 2, some of the chunks are transmitted to the target site via a first path and some of the chunks are transmitted to the target site via a second path. As a result, multiple sites act as sources of the chunks, even if these sites are intermediate sites. For example, the site 202 is a source of the chunk A with respect to the transmission of the chunk A to the site 206. Thus, the chunk A has multiple sources. By transmitting sources using multiple sources, the replication is completed more efficiently and may conserve resources, at least with respect to individual sites.

In one example, each of the sites may be implemented as a node or an appliance that includes at least a processor, storage, and other circuitry.

FIG. 3 illustrates another example of a distributed file system 300 in which an object is replicated. FIG. 3 is similar to FIG. 2. However, FIG. 3 illustrates that the object (or a portion thereof) is replicated using an intermediary node or site or using a site that is not a target of the replication process.

The distributed file system 300 includes at least sites 302, 304, 306, 308 and 310. In this example, the site 308 stores an object 332 that is to be replicated. The sites 302 and 306 are the targets or destinations of the replication process. When the process is completed, copies of the object will be present on each of the sites 302, 308 and 306.

In this example, the object 332 is chunked into chunks A, B and C. The replication engine 330 (an example of the replication engine 222) may then develop a plan for replicating the object 332 to the sites 302 and 306. The replication engine 330 may consider the various bandwidth of the uplinks and downlinks associated with each of the sites 302, 320, 306, 308 and 310. If the chunks A, B and C have different sizes or different priorities, this information may also be considered in conjunction with the bandwidths available in the distributed file system 300. A larger chunk, for example, may be suitable for a site or node that has higher bandwidth. A chunk having the highest priority may be replicated using the highest available bandwidth so that the chunk or object is replicated as quickly as possible.

In this example, chunks A and B are replicated in a manner that only involves the source site and the destination sites. Thus, the chunk as is replicated 312 from site 308 to the site 302. The site 302 keeps a copy of the chunk A and then replicates 318 the chunk A to the other intended destination of site 306. The site 308 replicates 314 the chunk B to the site 306 and the site 306 stores a copy of the chunk B. The site 306 then replicates 316 the chunk B to the site 302. Thus, the sites 302, 306 and 308 each have a copy of chunks A and B.

In this example, the chunk C is replicated through a node or proxy that is not an intended destination. More specifically, the chunk C is replicated through the site 310 to the sites 302 and 306. More specifically, the site 308 replicates 320 the chunk C to the site 310. The site 310 stores a copy of the chunk C, at least temporarily or until the replication is completed. The site 301 then replicates 322 the chunk C to the site 302 and replicates 324 the chunk C to the site 306. When complete, the sites 302, 306 and 308 each have a copy of the object 332. The site 310 may then delete the chunk C after the object 332 is successfully replicated to the sites 302 and 306.

When developing the overlay or replication plan, the replication engine may coordinate with the various sites such that the sites understand which chunks to store and which chunks to replicate. In particular, the replication engine 330 may coordinate with the sites in the distributed file system 300 using a ledger 334, which may be a distributed ledger. The ledger 334 may be a blockchain ledger. The ledger 334 is a record of transactions that have occurred or that are instructed.

For example, the replication engine 330 may publish a protection policy to the ledger 334. The protection policy may determine how an object is to be protected. Stated differently, the protection policy may specify that an object or a group of objects should be pinned or stored on certain sites. The protection policy associated with the object 332, for example, may pin the object 332 to the sites 302, 306 and 308. The object 332 is then copied to the sites or nodes based on the protection policy.

In one example, the protection policy may be used as part of a data protection system in a distributed file system. The protection policy can specify how an object is protected (e.g., backed up) by replicating the object to one or more sites. Objects having a high priority or requiring high availability may be copied to multiple sites. Objects that are not to be retained for a long period of time or have lesser importance may be copied to fewer sites. In each of these cases, however, the replication process is performed by developing a file overlay or plan for replicating the object or objects in accordance with the protection policy. The ledger 334 may also be used to confirm that the replication of objects or chunks has been successfully instructed and performed. The ledger 334 can verify that the data is protected and replicated in accordance with the relevant policy.

In another example, the replication engine 330 may determine, when developing the replication plan, that the chunk A already exists at site A. In other words, once the object 332 is chunked, the distributed file system can determine whether any of the chunks are already present in the distributed file system 300. In this case, the replication of chunk A may change. The site 308 would replicate the chunk A to the site 306 and the site 304 would replicate the chunk A to the site 302. The site 302 would not, in this example, be required to replicate the chunk A to the site 306.

When developing a replication plan, embodiments of the invention may thus consider characteristics of the network (e.g., bandwidth), conditions of the network (e.g., current workloads), and whether the chunks already exist in the network or in the distributed file system.

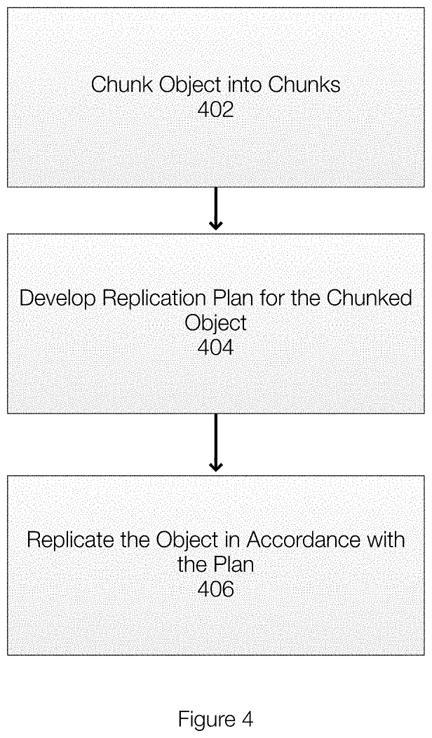

FIG. 4 illustrates an example of a method for replicating objects in a distributed file system. The method of FIG. 4 may begin by chunking 402 an object. The object may be chunked into same sized chunks or into different sized chunks. Next, a plan is developed 404 for replicating the object. Developing the plan may include considering the distributed file system. One or more factors may be considered when developing the plan. The factors may include, but are not limited to, connections or bandwidths between sites or nodes in the distributed file system, the existence of some of the chunks in the distributed file system, the rarity or uniqueness of the chunks, the source bandwidth, target bandwidths, priority of the chunks, and the protection policy stored in the ledger. These factors are evaluated when developing 404 the plan for replicating the object.

Once the plan is developed, the object or chunks are replicated 406 in accordance with the plan or overlay. Each of these steps or acts may be recorded in a ledger, which may also store the protection policy. The entries in the ledger may also be signed such that each step is acknowledged.

It should be appreciated that the present invention can be implemented in numerous ways, including as a process, an apparatus, a system, a device, a method, or a computer readable medium such as a computer readable storage medium or a computer network wherein computer program instructions are sent over optical or electronic communication links. Applications may take the form of software executing on a general purpose computer or be hardwired or hard coded in hardware. In this specification, these implementations, or any other form that the invention may take, may be referred to as techniques. In general, the order of the steps of disclosed processes may be altered within the scope of the invention.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein.

As indicated above, embodiments within the scope of the present invention also include computer storage media, which are physical media for carrying or having computer-executable instructions or data structures stored thereon. Such computer storage media can be any available physical media that can be accessed by a general purpose or special purpose computer.

By way of example, and not limitation, such computer storage media can comprise hardware such as solid state disk (SSD), RAM, ROM, EEPROM, CD-ROM, flash memory, phase-change memory (“PCM”), or other optical disk storage, magnetic disk storage or other magnetic storage devices, or any other hardware storage devices which can be used to store program code in the form of computer-executable instructions or data structures, which can be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ or ‘engine’ can refer to software objects or routines that execute on the computing system. The different components, modules, engines, and services described herein may be implemented as objects or processes that execute on the computing system, for example, as separate threads. While the system and methods described herein can be implemented in software, implementations in hardware or a combination of software and hardware are also possible and contemplated. In the present disclosure, a ‘computing entity’ may be any computing system as previously defined herein, or any module or combination of modules running on a computing system. Alternatively, modules, components, or engines may also include hardware such as a processor, memory and other circuitry needed to perform computing operations.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention can be performed in client-server environments, whether network or local environments, or in any other suitable environment. Suitable operating environments for at least some embodiments of the invention include cloud computing environments where one or more of a client, server, or target virtual machine may reside and operate in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for replicating an object in a distributed file system, the method comprising:
chunking an object at a source site into chunks, wherein the object is to be replicated to target sites;
evaluating sites included in the distributed network to develop a plan for replicating the object to the target sites; and
replicating the object to the target sites in accordance with the plan such that each of the source site and the target sits have a copy of the object.

2. The method of claim 1, further comprising determining whether any of the chunks exist on any sites in the distributed file system.

3. The method of claim 1, further comprising evaluating bandwidth between the sites in the distributed file system.

4. The method of claim 1, wherein replicating the object includes sending first chunks via a first path to the target sites and sending second chunks via a second path to the target sites.

5. The method of claim 4, wherein at least some of the chunks are sourced from more than one site.

6. The method of claim 1, wherein evaluating sites includes accounting for a protection policy stored in a ledger associated with the distributed file system, wherein the ledger is used to determine how many copies of the object should exist in the distributed file system and which sites should store the copies.

7. The method of claim 1, wherein the plan replicates the chunks of the object using only the source site and the target sites.

8. The method of claim 1, wherein the plan replicates the chunks using the source site, the target sites and at least one overlay site.

9. The method of claim 8, wherein the at least one overlay site transmits some of the chunks during replication of the object, wherein the at least one overlay site does not store the chunks after the object is replicated in the distributed file system.

10. A non-transitory computer readable medium including computer-readable instructions that, when executed by a processor, perform the method of claim 1.

11. A server computer configured for replicating an object in a distributed file system, the server computer comprising:
storage;
a processor; and
a replication engine configured to:
chunk an object at a source site into chunks, wherein the object is to be replicated to target server computers;
evaluate nodes included in the distributed network to develop a plan for replicating the object to the target sites, wherein the evaluation includes an evaluation of bandwidth associated with each of the nodes and between the nodes; and
replicate the object to the target sites in accordance with the plan such that each of the source site and the target sits have a copy of the object.

12. The server computer of claim 11, wherein the replication engine is configured to determine whether any of the chunks exist on any of the servers or storage in the distributed file system.

13. The server computer of claim 11, wherein the replication engine is configured to replicate the object by sending first chunks via a first path to the target sites and sending second chunks via a second path to the target sites.

14. The server computer of claim 11, wherein at least some of the chunks are sourced from more than one server computer during the replication.

15. The server computer of claim 11, wherein the replication engine is configured to account for a protection policy stored in a ledger associated with the distributed file system, wherein the ledger is used to determine how many copies of the object should exist in the distributed file system and which sites should store the copies.

16. The server computer of claim 11, wherein the plan replicates the chunks of the object using only the server computer and the target server computers.

17. The server computer of claim 11, wherein the plan replicates the chunks using the server computer, the target server computer and at least one overlay server computer.

18. The method of claim 18, wherein the at least one overlay server computer transmits some of the chunks during replication of the object, wherein the at least one overlay server computer does not store the chunks after the object is replicated in the distributed file system.

19. The server computer of claim 11, wherein the replication engine is configured to record the transactions associated with the replication of the object in a distributed ledger.

20. A method for replicating an object in a distributed file system, the method comprising:
chunking an object at a source site into chunks, wherein the object is to be replicated to target sites;
evaluating sites included in the distributed network to develop a plan for replicating the object to the target sites, wherein the plan accounts for bandwidth between the sites, including the source site and the target sites, in the distribute file system and a protection policy recorded in a distributed ledger associated with the distributed file system; and
replicating the object to the target sites in accordance with the plan such that each of the source site and the target sits have a copy of the object, wherein the plan replicates the object such that multiple sites in the distributed file system serve as source sites for at least some of the chunks.
